(19) United States
(12) Patent Application Publication
(10) Pub. No.: US 2011/0226000 A1
(43) Pub. Date: Sep. 22, 2011

(54) Water-sputtering Ring and Water-dispersing Fan Assembly for an Air Conditioner

(76) Inventor: Ming-Tsung Chiu, Chung-Ho (TW)

(21) Appl. No.: 12/726,438

(22) Filed: Mar. 18, 2010

(51) Int. Cl. F25D 21/00; B05B 3/00; B05B 3/02

(52) U.S. Cl. 62/272; 239/225.1; 239/263.1

(57) ABSTRACT

A water-dispersing fan assembly for an air conditioner has a water-sputtering ring and a fan. The water-sputtering ring has an annular body and at least one set of multiple water-disturbing ribs formed on one or both of the annular outer surfaces. Each water-disturbing rib is curved and arranged substantially radially. The fan is connected coaxially to the water-sputtering ring and has a hub; multiple blades formed on and protrude radially from the hub and an annular bracket formed around the blades, arranged concentrically with the hub and connected to the water-sputtering ring so that the water-sputtering ring is mounted securely around the annular bracket. The water-dispersing fan assembly prevents condensed water of the air conditioner from dropping.

### BACKGROUND OF THE INVENTION

1. Field of the Invention

The present invention relates to an air conditioner, especially to a water-dispersing fan assembly for an air conditioner that has a water-sputtering ring and prevents the air conditioner from dropping condensed water.

2. Description of the Prior Arts

An air conditioner in accordance with the prior art is mounted on a wall of a building and has a casing, a compressor, an evaporator, a condenser, a coolant and a fan assembly. The casing has a partition to form inner and outer chambers respectively disposed indoors and outdoors. The compressor is mounted in the outer chamber of the casing. The evaporator is mounted in the inner chamber of the casing and is connected to the compressor. The condenser is mounted in the outer chamber of the casing and is connected between the compressor and evaporator. The fan assembly is mounted through the partition and aligns with the condenser in order to assist heat exchange between the condenser and cooled air. The coolant fills the compressor and circulates through to evaporator and condenser to move heat inside to outside.

Because water is condensed on the evaporator when the air conditioner is operated, a discharge hole with a pipe is mounted on the bottom of air conditioner to discharge the condensed water. However, the pipe ages and breaks easily and inadvertently generates drops to interfere with persons or objects on the ground.

Another conventional air conditioner without generating drops is operated to collect condensed water into one place therein and uses a fan to sputter the condensed water onto the condenser. The high temperature condenser vaporizes the condensed water into gas to spread out to the atmosphere. However, the water-sputtering efficiency of the fan is not ideal.

To overcome the shortcomings, the present invention provides a water-dispersing fan assembly for an air conditioner to mitigate or obviate the aforementioned problems.

### SUMMARY OF THE INVENTION

The main objective of the present invention is to provide a water-dispersing fan assembly for an air conditioner that has a water-sputtering ring and prevents the air conditioner from dropping condensed water.

A water-dispersing fan assembly for an air conditioner has a water-sputtering ring and a fan. The water-sputtering ring has an annular body and at least one set of multiple water-disturbing ribs formed on one or both of the annular outer surfaces. Each water-disturbing rib is curved and arranged substantially radially. The fan is connected coaxially to the water-sputtering ring and has a hub; multiple blades formed on and protrude radially from the hub and an annular bracket formed around the blades, arranged concentrically with the hub and connected to the water-sputtering ring so that the water-sputtering ring is mounted securely around the annular bracket. The water-dispersing fan assembly prevents condensed water of the air conditioner from dropping.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a water-dispersing fan assembly for an air conditioner in accordance with the present invention;

FIG. 2 is an enlarged perspective view of the water-sputtering ring of the water-dispersing fan assembly in FIG. 1;

FIG. 3 is an exploded perspective view of an air conditioner with the water-dispersing fan assembly in FIG. 1;

FIG. 4 is a perspective view of the air conditioner incorporated with the water-dispersing fan assembly in FIG. 4; and

FIG. 5 is a side view in partial section of the air conditioner with the water-dispersing fan assembly in FIG. 4.

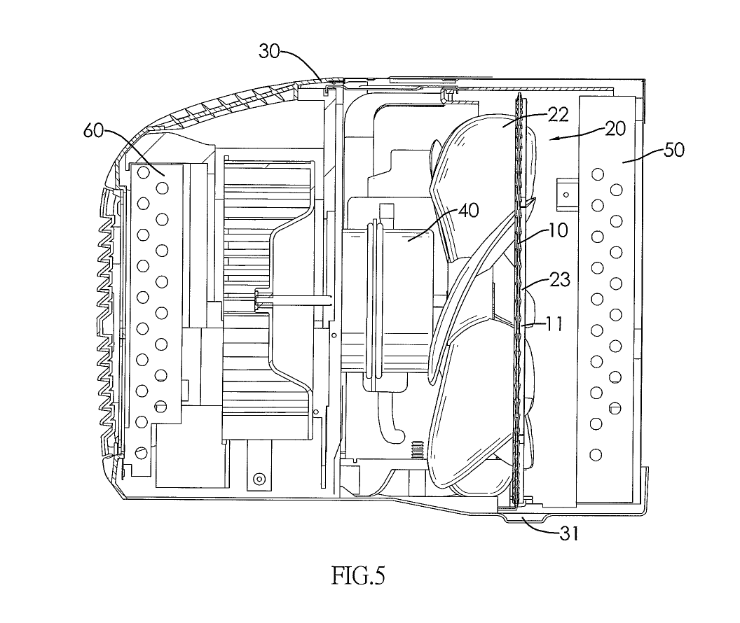

### DETAILED DESCRIPTION OF THE PREFERRED EMBODIMENTS

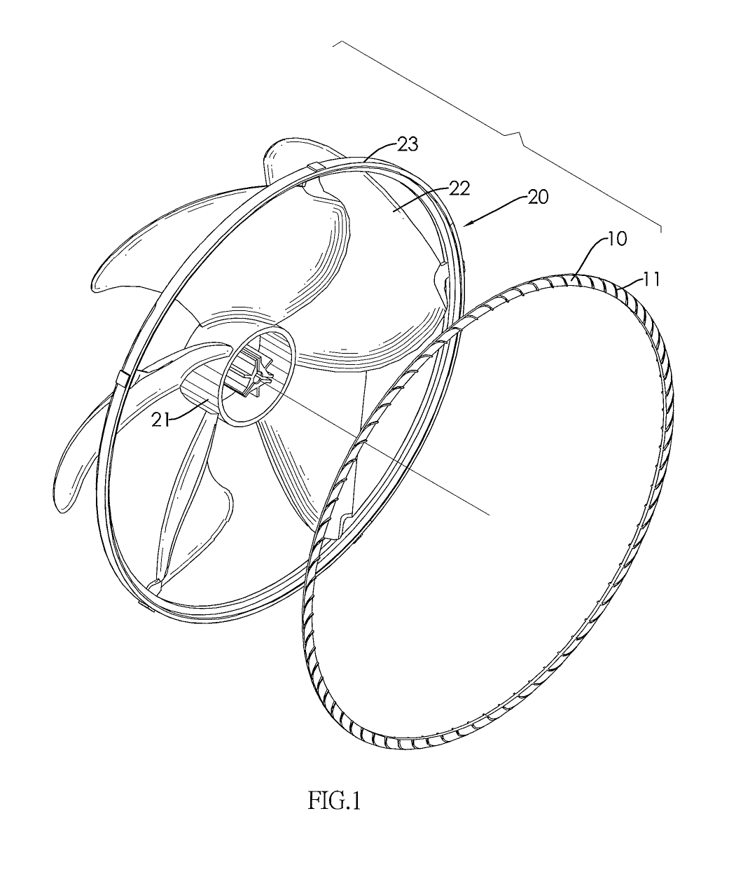

With reference to FIG. 1, a water-dispersing fan assembly for an air conditioner in accordance with the present invention comprises a water-sputtering ring (10) and a fan (20).

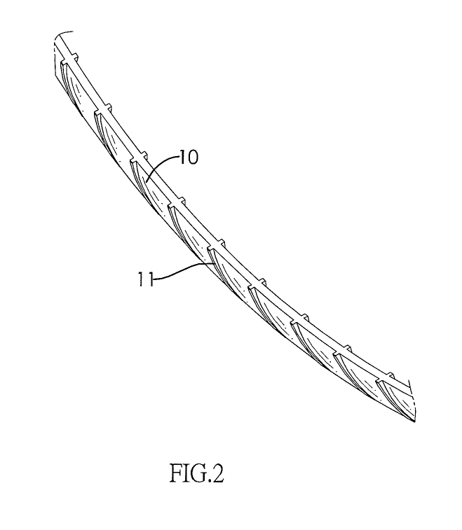

With further reference to FIG. 2, the water-sputtering ring (10) has an annular body and at least one set of multiple water-disturbing ribs (11).

The annular body has an inside periphery, an outside periphery and two opposite annular outer surfaces.

The at least one set of the water-disturbing ribs (11) is formed on one or both of the annular outer surfaces. Preferably, two sets of multiple water-disturbing rings (11) are symmetrically arranged and are respectively formed on the annular outer surfaces. Each water-disturbing rib (11) is curved and arranged substantially radially, may be tapered and have an inside end at the inside periphery and an outside end at the outside periphery so that the water-disturbing rib (11) is gradually thinned and narrowed from the inside end to the outside end. When the water-sputtering ring (10) contacts water and rotates, the water moves along the water-disturbing ribs (11) from the outside end to the inside end and is lifted into the air by centrifugal force provided by the rotating water-sputtering ring (10).

The fan (20) is connected coaxially to the water-sputtering ring (10) and has a hub (21), multiple blades (22) and an annular bracket (23). The blades (22) are formed on and protrude radially from the hub (21). The annular bracket (23) is formed around the blades (22), is arranged concentrically with the hub (21) and is connected to the water-sputtering ring (20) so that the water-sputtering ring (20) is mounted securely around the annular bracket (23).

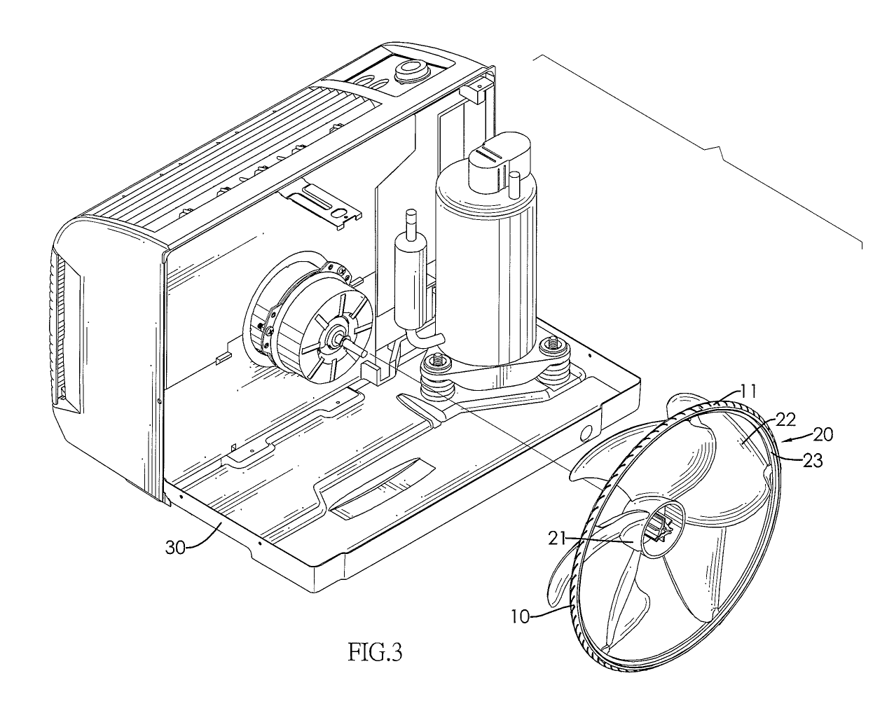

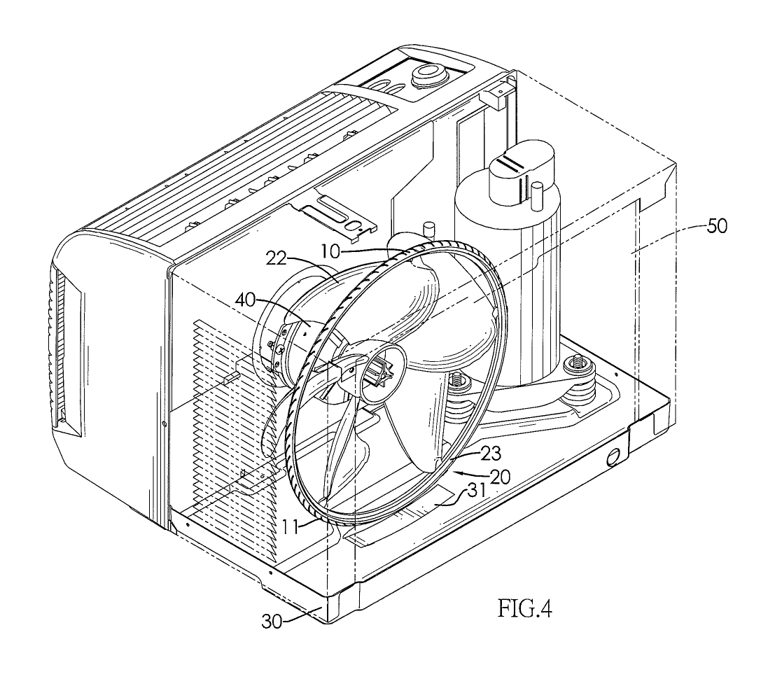

With further reference to FIGS. 3 and 4, The water-dispersing fan assembly is mounted an air conditioner (30). The air conditioner (30) has a casing, a motor (40), a condenser (50) and an evaporator (60). The casing has a bottom plate and a water collection sink (31) formed on an inner top surface of the bottom plate to collect condensed water from the evaporator (60). The motor (40) is mounted in the casing and has a shaft. The condenser (50) and evaporator (60) are mounted in the casing.

The water-dispersing fan assembly is mounted in the casing between the condenser (50) and evaporator (60). The hub (21) of the fan (20) is mounted securely on the shaft of the motor (40) in the air conditioner (30) and the water-sputtering ring (10) partially extends in the water collection sink (31).

When the air conditioner (30) operates, the evaporator (60) cools down airflow sucked into the air conditioner so that moisture in the airflow is condensed into water and attached to the evaporator (60). The condensed water is flowed into the water collection sink (31). Compressed internal refrigerant heats the condenser (50) so that an outer surface of the condenser (50) has a high temperature. The heated condenser (50) is cooled down by the rotating water-dispersing fan assembly. Simultaneously, the rotating water-sputtering ring (10) sputters and lifts the condensed water in the water collection sink (31) into mist. The mist is blown onto the heated condenser (50) and is evaporated by the high temperature of the condenser (50). The evaporated mist on the condenser (50) also expedites the cooling of the condenser (50).

Since the water-dispersing fan assembly dissipates heat from the condenser (20) using convection by the air and by sputtering water, the water-dispersing fan assembly has improved thermal dispersion efficiency, especially in dry climates as water evaporates to remove heat.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A water-sputtering ring for an air conditioner comprising
an annular body having an inside periphery, an outside periphery and two opposite annular outer surfaces; and
a set of multiple water-disturbing ribs formed on one of the annular outer surfaces and each water-disturbing rib being curved and arranged substantially radially.

2. The water-sputtering ring for an air conditioner as claimed in claim 1, wherein each water-disturbing rib is tapered and has an inside end at the inside periphery and an outside end at the outside periphery, and the water-disturbing rib is gradually thinned and narrowed from the inside end to the outside end.

3. The water-sputtering for an air conditioner as claimed in claim 2 further comprising another set of multiple water-disturbing rib formed on the other annular outer surface of the annular body.

4. A water-dispersing fan assembly for an air conditioner comprising
a water-sputtering ring having
an annular body having an inside periphery, an outside periphery and two opposite annular outer surfaces; and
a set of multiple water-disturbing ribs formed on one of the annular outer surfaces and each water-disturbing rib being curved and arranged substantially radially; and
a fan connected coaxially to the water-sputtering ring and having
a hub;
multiple blades formed on and protruding radially from the hub; and
an annular bracket formed around the blades, arranged concentrically with the hub and connected to the water-sputtering ring so that the water-sputtering ring is mounted securely around the annular bracket.

5. The water-dispersing fan assembly for an air conditioner as claimed in claim 4, wherein each water-disturbing rib is tapered and has an inside end at the inside periphery and an outside end at the outside periphery, and the water-disturbing rib is gradually thinned and narrowed from the inside end to the outside end.

6. The water-dispersing fan assembly for an air conditioner as claimed in claim 5 further comprising another set of multiple water-disturbing rib formed on the other annular outer surface of the annular body.
